(19) United States
(12) Patent Application Publication
(10) Pub. No.: US 2016/0307252 A1
(43) Pub. Date: Oct. 20, 2016

(54) METHOD AND APPARATUS FOR PROCESSING TARGET ARTICLE INFORMATION

(71) Applicant: Tencent Technology (Shenzhen) Company Limited, Shenzhen (CN)

(72) Inventors: Tao ZHANG, Shenzhen (CN); Lichun LI, Shenzhen (CN); Kai HE, Shenzhen (CN); Feng LU, Shenzhen (CN); Sen WANG, Shenzhen (CN)

(73) Assignee: Tencent Technology (Shenzhen) Company Limited, Shenzhen (CN)

(21) Appl. No.: 15/191,133

(22) Filed: Jun. 23, 2016

Related U.S. Application Data
(63) Continuation of application No. PCT/CN2014/095328, filed on Dec. 29, 2014.

(30) Foreign Application Priority Data
Dec. 27, 2013 (CN) 201310737671.1

(51) Int. Cl. G06Q 30/06

(52) U.S. Cl. CPC G06Q 30/0623

(57) ABSTRACT

A method and apparatus for processing target article information, the method comprising: receiving a target article information viewing request sent by a user terminal, the target article information viewing request comprising an identifier of a target article and a terminal identifier; determining a current location of the user terminal according to the terminal identifier; on the basis of the current location of the user terminal and the identifier of the target article, obtaining from a preset information database the information of the target article located within a preset range centering on the current location of the user terminal; and returning the obtained information of the target article to the user terminal.

### CROSS REFERENCE TO RELATED APPLICATION

The present application is a continuation of International Application No. PCT/CN2014/095328, filed on Dec. 29, 2014, which claims priority to Chinese Patent Application No: 201310737671.1, titled “METHOD, APPARATUS AND SYSTEM FOR PROCESSING COMMODITY INFORMATION” and filed on Dec. 27, 2013 with the State Intellectual Property Office of People's Republic of China, both of which arc incorporated herein by reference their entirety.

### TECHNICAL FIELD

The present disclosure relates to the field of computer technology, and in particular to a method and an apparatus for processing information about a target article.

### BACKGROUND

With rapid development of internet technology and popularization of various intelligent terminals, new shopping ways such as electronic commerce, Business To Business (B2B) and online shopping emerge.

Conventionally, in the electronic commerce or online shopping, a user may view information about online commodities of various merchants over the network, and after the user selects to buy a commodity, the merchant picks out the goods from a real warehouse and delivers the goods to the user. In this case, the online commodity information and the offline real commodity information are independent from each other.

Since the online commodity information and the offline real commodity information are independent from each other conventionally, the online commodity information is not synchronous with the offline real commodity information, thereby the user can not obtain accurate information about commodities in a timely manner.

### SUMMARY

A method and an apparatus for processing information about a target article is provided according to embodiments of the present disclosure.

A method for processing information about a target article includes: receiving a request for viewing the information about the target article sent by a user terminal, where the request for viewing the information about the target article includes an identifier of the target article and a terminal identifier; determining a current location of the user terminal based on the terminal identifier; obtaining, based on the current location of the user terminal and the identifier of the target article, the information about the target article located within a preset range centering on the current location of the user terminal, from a preset information database; and returning the obtained information about the target article to the user terminal.

An apparatus for processing information about a target article includes one or more processors and a storage medium having operation instructions stored thereon, that when executed by the processor, cause the processor to perform the following steps: receiving a request for viewing the information about the target article sent by a user terminal, where the request for viewing the information about the target article includes an identifier of the target article and a terminal identifier; determining a current location of the user terminal based on the terminal identifier; obtaining, based on the current location and the identifier of the target article, the information about the target article located within a preset range centering on the current location of the user terminal, from a preset information database; and returning the obtained information about the target article to the user terminal.

According to embodiments of the present disclosure, a request for viewing information about a target article sent by a user terminal is received; a current location of the user terminal is determined based on a terminal identifier carried in the request for viewing the information about the target article; information about the target article located within a preset range centering on the current location of the user terminal is obtained from a preset information database based on the current location and an identifier of the target article; and the obtained information about the target article is returned to the user terminal. In the solution, the information about the target article within a preset range is provided to the user terminal based on the current location of the user terminal, therefore the user can obtain accurate information about the target article fully and in a timely manner.

### BRIEF DESCRIPTION OF THE DRAWINGS

FIG. 1 is a flow chart of a method for processing information about a target article according to an embodiment of the disclosure;

FIG. 2 is a flow chart of a method for processing information about a target article according to an embodiment of the disclosure;

FIG. 3a is a schematic diagram of a scenario of a method for processing information about a target article according to an embodiment of the disclosure;

FIG. 3b is a schematic diagram of another scenario of a method for processing information about a target article according to an embodiment of the disclosure;

FIG. 3c is a schematic diagram of an application scenario of a method for processing information about a target article according to an embodiment of the disclosure;

FIG. 3d is another flow chart of a method for processing information about a target article according to an embodiment of the disclosure;

FIG. 4 is another flow chart of a method for processing information about a target article according to an embodiment of the disclosure;

FIG. 5a is a structure schematic diagram of an apparatus for processing information about a target article according to an embodiment of the disclosure;

FIG. 5b is another structure schematic diagram of an apparatus for processing information about a target article according to an embodiment of the disclosure;

FIG. 6 is another structure schematic diagram of an apparatus for processing information about a target article according to an embodiment of the disclosure; and

FIG. 7 is a structure schematic diagram of a server according to an embodiment of the disclosure.

### DETAILED DESCRIPTION OF THE EMBODIMENTS

Technical solutions in embodiments of the present disclosure are described clearly hereinafter in conjunction with the drawings in the embodiments of the present disclosure. Apparently, the described embodiments are only a few rather than all of embodiments of the present invention. All the other embodiments obtained by those skilled in the art without creative effort on the basis of the embodiments in the present disclosure fall within the scope of protection of the present invention.

A method, an apparatus and a system for processing information about a commodity are provided according to embodiments of the disclosure, which are respectively described in detail below.

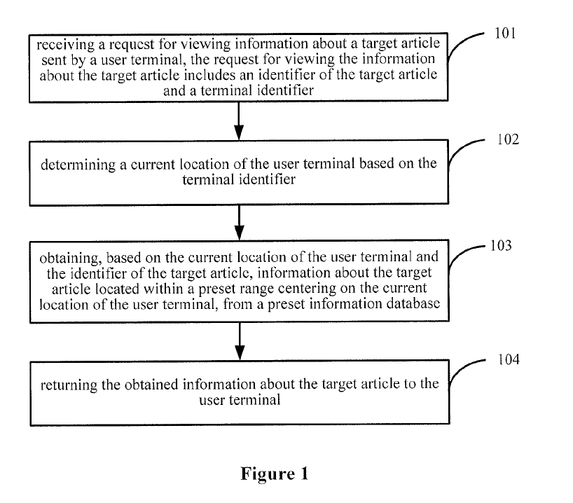

A method for processing information about a target article is provided according to an embodiment of the disclosure. The method may be applied to a server. As shown in FIG. 1, the method includes steps 101 to 104.

In stcp 101, a request for viewing information about a target article sent by a user terminal is received. The request for viewing the information about the target article includes an identifier of the target article and a terminal identifier.

In step 102, a current location of the user terminal is determined based on the terminal identifier.

In step 103, the information about the target article located within a preset range centering on the current location of the user terminal is obtained from a preset information database based on the current location of the user terminal and the identifier of the target article.

In step 104, the obtained information about the target article is returned to the user terminal.

A method for processing information about a target article is provided according to an embodiment. The embodiment takes an example that the target article is a commodity that can be sold online and offline, and the description is taken from a view of an apparatus for processing the information about the target article. The apparatus for processing the information about the target article may be integrated into a server.

The method for processing the information about the target article provided according to the embodiment of the disclosure includes: receiving a request for viewing information about a target commodity, which includes a commodity identifier of the target commodity and a terminal identifier, sent by a user terminal; determining a current location of the user terminal based on the terminal identifier; obtaining, based on the current location and the commodity identifier of the target commodity, commodity information about the target commodity of nearby stores, from a preset information database; and returning the commodity information about the target commodity of the nearby stores to the user terminal.

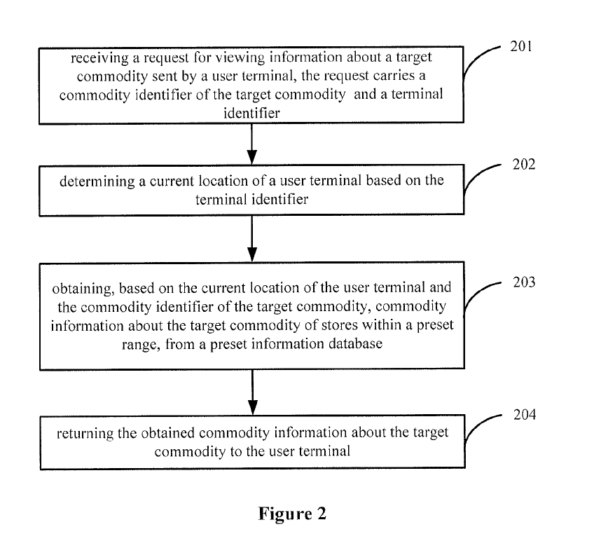

As shown in FIG. 2, the method for processing the information about the target article includes steps 201 to 204.

In step 201, a request for viewing information about a target commodity sent by a user terminal is received. The request carries a commodity identifier of the target commodity and a terminal identifier.

The user terminal can be located based on the terminal identifier. In order to improve flexibility and accuracy for viewing commodity information, the request for viewing the information about the target commodity may further carries a scope for viewing the target commodity. For example, a region for viewing, a price range of the commodity, a type of the commodity, and/or a color of the commodity may be specified in the request for viewing the information about the target commodity.

The commodity identifier may be, for example, a name, a type, a barcode or a two-dimensional code of the commodity.

In step 202, a current location of the user terminal is determined based on the terminal identifier.

For example, the user terminal can be located by using a base station or the global positioning system (GPS) based on the terminal identifier, to determine the current location of the user terminal.

In step 203, commodity information about the target commodity of stores within a preset range is obtained from a preset information database based on the current location of the user terminal and the commodity identifier of the target commodity.

The preset range may be set according to requirement of practical application. For example, the preset range may be set to be 100 m, 500 m or 1000 m, or may be set by using a journey such as a five minutes' walk, a five minutes' drive, or a ten minutes' drive, which is not described herein.

For example, stores having the commodity information about the target commodity are obtained from the preset information database based on the commodity identifier of the target commodity; stores within the preset range centering on the current location are selected from the stores having the commodity information about the target commodity; and commodity information about the target commodity of the stores within the preset range are obtained.

The commodity information may include: the commodity identifier, an identifier of a general warehouse to which the commodity belongs, an identifier of a region warehouse to which the commodity belongs, an identifier of a store to which the commodity belongs, stock keeping unit (SKU) information (short for stock information) about the commodity in the general warehouse, SKU information about the commodity in the region warehouse, SKU information about the commodity in the store, and/or promotion information about the commodity in the store, etc.

Besides the storage information, the SKU information may also include the number of original commodities, the number of the commodities which have been sold, and the number of the commodities which are remained.

The information database may be established by obtaining commodity information about various commodities in real time. That is, before receiving the request for viewing the information about the target commodity sent by the user terminal (step 201), the method further includes:

obtaining commodity information about a specified commodity, such as obtaining one or more of: a commodity identifier of the specified commodity, an identifier of a general warehouse to which the commodity belongs, an identifier of a region warehouse to which the commodity belongs, an identifier of a store to which the commodity belongs, stock information about the commodity in the general warehouse, stock information about the commodity in the region warehouse, stock information about the commodity in the store and promotion information about the commodity in the store; and establishing the information database based on the commodity information about the specified commodity.

For example, the commodity information about the specified commodity uploaded by various merchants may be received via a standard data interface or an adapter.

The commodity information about the specified commodity uploaded by the merchant may be uploaded actively by the merchant, or uploaded by the merchant according to a prompt by a system after automatic system detection. In addition, both the standard data interface and the adapter can be connected to an enterprise resource planning system (ERP) of the merchant, therefore there is no need to modify the existing ERP system.

In addition, after the information database is established based on the commodity information, the information database may be updated in real time. For example, the information database may be updated when the commodity information is changed or at a preset period according to a preset increment synchronization strategy.

The increment synchronization strategy may be set according to requirement of practical application. For example, a synchronization time or a synchronization mode may be set; for example, it may he set that the synchronization is performed in the unit of hour and the update is only for the changed data to reduce system load.

Optionally, in a case that the request for viewing the information about the target commodity further carries a scope for viewing the target commodity, such as a price range of the commodity, a type of the commodity and a color of the commodity, the method for processing the information about the commodity further includes: after step 203 of the embodiment,

screening the obtained commodity information about the target commodity of the stores according to the scope for viewing the target commodity, to obtain screened commodity information.

For example, the commodity information meeting the scope (i.e., the scope for viewing the target commodity) may be screened out from the obtained commodity information about the target commodity of the nearby stores according to the region for viewing by the user, the price range of the commodity, the type of the commodity and/or the color of the commodity. For convenience of description, the commodity information meeting the scope after the screening is referred to as screened commodity information in the embodiments of the disclosure.

In step 204, the commodity information about the target commodity of the stores within the preset range obtained in step 203 is returned to the user terminal.

For example, if information obtained in step 203 is all related commodity information about the target commodity of the stores within the preset range, the all related commodity information may be returned to the user terminal; if information obtained in step 203 is SKU information and/or promotion information about the commodity of the stores within the preset range, the obtained SKU information and/or promotion information about the commodity of the stores within the preset range may be returned to the user terminal; and if information obtained in step 203 is screened commodity information, the screened commodity information may be returned to the user terminal.

From the above, in the embodiment of the disclosure, the request for viewing the information about the target commodity sent by the user terminal is received, where the request carries the identifier of the user terminal and the commodity identifier of the target commodity; the current location of the user terminal is determined based on the identifier of the terminal; the commodity information about the target commodity of the stores within the preset range is obtained from a preset information database based on the current location and the commodity identifier of the target commodity; and the commodity information about the target commodity of the stores within the preset range is returned to the user terminal. In the solution, the commodity information about the target commodity of the stores within the preset range can be provided to the user terminal based on the current location of the user terminal, therefore the user can obtain accurate information about the commodity fully and in a timely manner, which is convenient to the user, improves the quality of user experience, and further improves transaction achievement.

According to the method described in the embodiment as shown in FIG. 2, an example is further described in detail hereinafter.

In the embodiment, an example is taken that an apparatus for processing information about a target article is integrated into a server.

Commodity information about a specific commodity is obtained; and then a information database is established based on the commodity information. The information database may be saved in the server or in other independent storage device. For convenience of description, in the embodiment, the information database saved in the server is taken as an example for illustration.

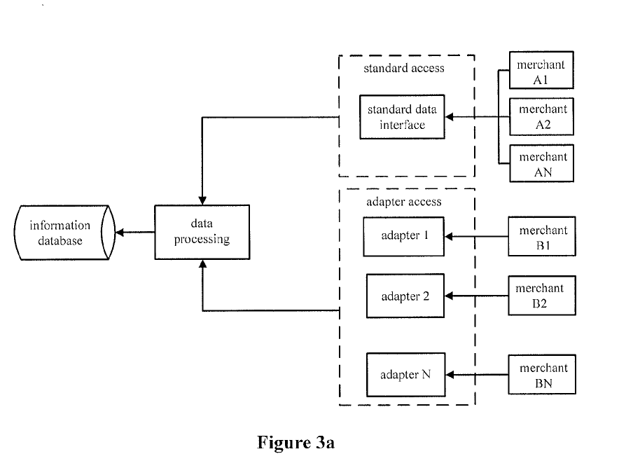

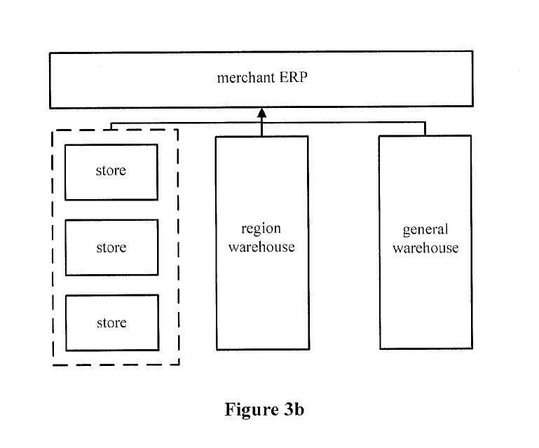

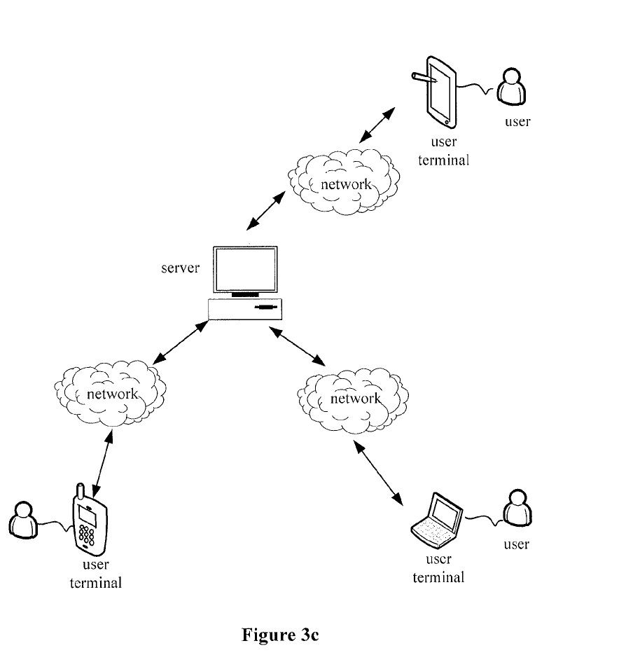

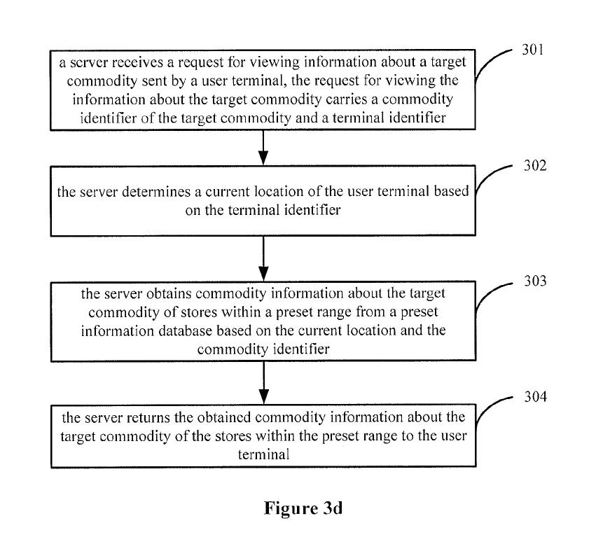

As shown in FIG. 3a, various merchants can be connected to the server via a standard data interface or an adapter, to achieve synchronization with data in the information database in the server. For example, when certain commodity information of a certain merchant is changed, the changed commodity information may be uploaded to the server via the standard data interface or the adapter, the data is processed by the server, and then the corresponding commodity information in the information database is updated. Whether a standard access (i.e., a standard data interface) or an adaptor access (i.e., an adaptor) is adopted may be set according to requirement of practical application. For example, a specialized data interface may be provided for a large merchant such as merchant A1, merchant A2, . . . and merchant AN according to requirement of the large merchant; and an adapter may be provided for a small merchant such as merchant B1, merchant B2, . . . and merchant BN. The establishment and update of the information database may refer to the embodiment as shown in FIG. 2, which is not described herein.

As shown in FIG. 3b, the commodity information of the various merchants may further include: related information about a general warehouse, a region warehouse and a store. For example, the commodity information may include: a commodity identifier, an identifier of a general warehouse to which the commodity belongs, an identifier of a region warehouse to which the commodity belongs, an identifier of a store to which the commodity belongs, SKU information about the commodity in the general warehouse, SKU information about the commodity in the region warehouse, SKU information about the commodity in the store, and/or promotion information about the commodity in the store, etc. That is, an ERP system of the merchant is associated with systems of the general warehouse, the region warehouse and the store, therefore it may be ensured that the granularity of the commodity information in the ERP system of the merchant is refined to the store, which makes the commodity information More coincide with real information about the commodity offline.

Based on the scenario described above, the method for processing the information about the commodity will be described in detail hereinafter.

As shown in FIG. 3c, a user may communicate with a server through a network by using a user terminal such as a smart phone, a tablet, or a home computer, to achieve a purpose of viewing information about a target commodity. For example, taking the application scenario as an example and referring to FIG. 3d, a method for processing information about a commodity may include steps 301 to 304.

In step 301, a server receives a request for viewing information about a target commodity sent by a user terminal. The request for viewing the information about the target commodity carries a commodity identifier of the target commodity and a terminal identifier.

The commodity identifier may be, for example, a name, a type, a barcode or a two-dimensional code of the commodity.

In step 302, the server determines a current location of the user terminal based on the terminal identifier upon receipt of the request for viewing the information about the target commodity sent by the user terminal.

For example, the user terminal may be located based on the terminal identifier by using a current longitude and latitude of the user terminal, a base station, or manual calibration by the user, to determine the current location of the user terminal.

In step 303, the server obtains commodity information about the target commodity of stores within a preset range from a preset information database based on the current location and the commodity identifier. The commodity information may be, for example, SKU information about the target commodity and/or promotion information about the target commodity. The commodity information may further include a commodity identifier of the target commodity, an identifier of a general warehouse to which the commodity belongs, an identifier of a region warehouse to which the commodity belongs, an identifier of a store to which the commodity belongs, SKU information about the commodity in the general warehouse, and/or SKU information about the commodity in the region warehouse.

The preset range may be set according to requirement of practical application. For example, the preset range may be set to be 100 m, 500 m or 1000 m, or even may be set by using a journey such as a five minutes' walk, a five minutes' drive, or a ten minutes' drive, which is not described herein.

For example, the server may obtain all stores having the commodity information about the target commodity from the preset information database based on the commodity identifier of the target commodity; select stores within a preset range centering on the current location from all the stores having the commodity information about the target commodity; and then obtain the commodity information about the target commodity of the stores within the preset range.

Commodity information about various commodities is recorded in the information database. The commodity information includes one or more of a commodity identifier, an identifier of a general warehouse to which the commodity belongs, an identifier of a region warehouse to which the commodity belongs, an identifier of a store to which the commodity belongs, SKU information about the commodity in the general warehouse, SKU information about the commodity in the region warehouse, SKU information about the commodity in the store, and promotion information about the commodity in the store.

In step 304, the server returns, to the user terminal, the obtained commodity information about the target commodity of the stores within the preset range, such as SKU information about the target commodity and/or promotion information about the target commodity.

The user then may select, according to the received commodity information such as the SKU information and/or promotion information about the commodity of the stores within the preset range, the needed commodity for purchase, or go to the sores for selection and purchase, which is not described herein.

From the above, in the embodiment of the disclosure, the server receives the request for viewing the information about the target commodity sent by the user terminal, where the request carries the identifier of the user terminal and the identifier of the target commodity; locates the user terminal based on the terminal identifier to determine the current location of the user terminal; obtains the commodity information about the target commodity of the stores within the preset range from the preset information database based on the current location and the commodity identifier; and provides the commodity information to the user terminal. In the solution, the commodity information about the target commodity of the stores within the preset range can be provided to the user terminal based on the current location of the user terminal, therefore the user can obtain accurate information about the commodity in a timely manner. In addition, the commodity information provided in the solution not only includes online commodity, but also includes other offline information such as storage information and other information about the commodity of various stores. That is, the online commodity information and the offline commodity information can be synchronized. Therefore, accurate and full commodity information can be provided to the user, which is convenient to the user, improves the quality of user experience, and further improves transaction achievement.

The same part of the embodiment as the embodiment shown in FIG. 3 is in that, the embodiment takes an example that the apparatus for processing the information about the target article is integrated into the server and the embodiment is applied to the scene described in the embodiment shown in FIG. 3. Reference is made to FIG. 3a, FIG. 3b and FIG. 3c, and the detailed description thereof is omitted. The different part of the embodiment From the embodiment shown in FIG. 3 is in that, the request sent by the user terminal in the embodiment further carries a standard for viewing the target commodity, besides the commodity identifier of the commodity and the terminal identifier. The embodiment will be described below in detail.

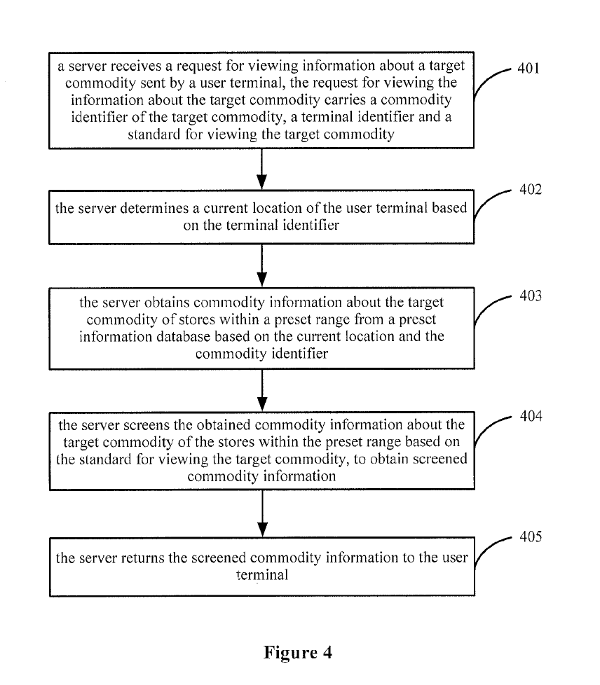

FIG. 4 illustrates a method for processing information about a target article. The method may include steps 401 to 405.

In step 401, a server receives a request for viewing information about a target commodity sent by a user terminal. The request for viewing the information about the target commodity may carry a commodity identifier of the target commodity, a terminal identifier and a standard for viewing the target commodity.

In the embodiment, besides the commodity identifier of the target commodity and the terminal identifier, the request for viewing the information about the target commodity may further carry a standard for viewing the target commodity, such as a region for viewing, a price range of the commodity, a type of the commodity and/or a color of the commodity.

The commodity identifier may be, for example, a name, a type, a barcode or a two-dimensional code of the commodity.

In step 402, the server determines a current location of the user terminal based on the terminal identifier upon receipt of the request for viewing the information about the target commodity sent by the user terminal.

For example, the user terminal may be located based on the terminal identifier by using a current longitude and latitude of the user terminal, a base station or manual calibration by the user, to determine the current location of the user terminal.

In step 403, the server obtains commodity information about the target commodity of stores within a preset range from a preset information database based on the current location and the commodity identifier. The commodity information may be, for example, SKU information about the target commodity and/or promotion information about the target commodity. The commodity information may further include a commodity identifier of the target commodity, an identifier of a general warehouse to which the commodity belongs, an identifier of a region warehouse to which the commodity belongs, an identifier of a store to which the commodity belongs, SKU information about the commodity in the general warehouse, and/or SKU information about the commodity in the region warehouse.

The preset range may be set according to requirement of practical application. For example, the preset range may be set to be 100 m, 500 m, or 1000 m, or even may be set by using a journey such as a 5 minutes' walk, a 5 minutes' drive, or a 10 minutes' drive, which is not described herein.

For example, the server may obtain all stores having the commodity information about the target commodity from the preset information database based on the commodity identifier of the target commodity; select stores within a preset range centering on the current location from all the stores having the commodity information about the target commodity; and then obtain commodity information about the target commodity of the stores within the preset range.

Commodity information about various commodities is recorded in the information database. The commodity information includes one or more of: a commodity identifier, an identifier of a general warehouse to which the commodity belongs, an identifier of a region warehouse to which the commodity belongs, an identifier of a store to which the commodity belongs, SKU information about the commodity in the general warehouse, SKU information about the commodity in the region warehouse, SKU information about the commodity in the store, and promotion information about the commodity in the store.

In step 404, the server screens the obtained commodity information about the target commodity of the stores within the preset range, based on the standard for viewing the target commodity, to obtain screened commodity information.

For example, commodities meeting a condition may be screened out from the obtained commodity information about the target commodity of the nearby stores, based on a region for viewing by the user, a price range of the commodity, a type of the commodity and/or a color of the commodity, to obtain screened commodity information.

In step 405, the server returns the screened commodity information obtained in step 404 to the user terminal.

For example, if the information obtained in step 404 is commodity information within a certain price range, the commodity information within the certain price range may be returned to the user terminal.

From the above, in the embodiment of the disclosure, the server receives the request for viewing the information about the target commodity sent by the user terminal; obtains commodity information from the preset information database based on the commodity identifier, the terminal identifier and the scope for viewing the target commodity which are carried in the request for viewing the information about the target commodity; and provides the commodity information to the user terminal. In the solution, the commodity information about the target commodity of the stores within the preset range can be provided to the user terminal based on the current location of the user terminal, and the commodity information is further screened according to the scope for viewing the target commodity, therefore the user can obtain accurate information about the commodity flexibly and in a timely manner. In addition, the commodity information provided in the solution not only includes online commodity, but also includes other offline information such as storage information and other information about the commodity of the various stores. That is, the online commodity information and the offline commodity information can be synchronized. Therefore, accurate and full commodity information can be provided to the user, which is convenient to the user, improves the quality of user experience, and further improves transaction achievement.

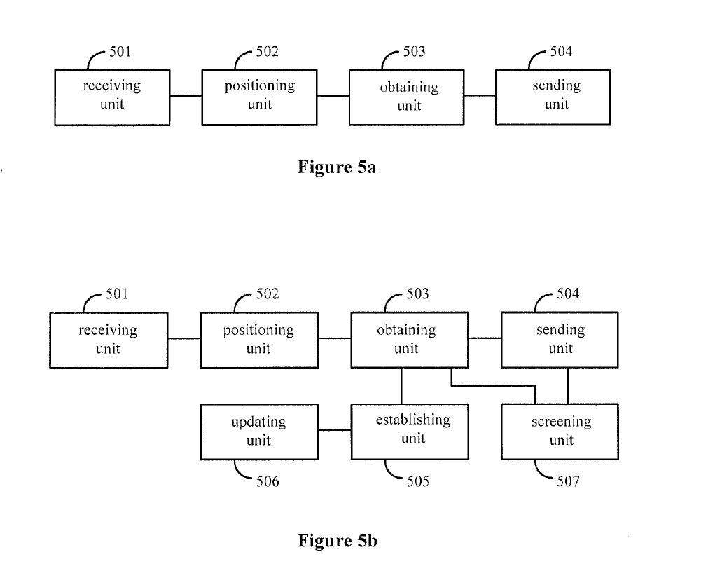

To better implement the above method, an apparatus for processing information about a target article is provided according to an embodiment of the disclosure. As shown in FIG. 5a, the apparatus for processing information about a target article includes: a receiving unit 501, a positioning unit 502, an obtaining unit 503 and a sending unit 504.

The receiving unit 501 is configured to receive a request for viewing information about a target commodity sent by a user terminal. The request carries an identifier of the target commodity and an identifier of the user terminal.

The user terminal may be located based on the identifier of the user terminal. The request for viewing the information about the target commodity may further carry a scope for viewing the target commodity. For example, a region for viewing, a price range of the commodity, a type of the commodity and/or a color of the commodity may be specified in the request for viewing the information about the target commodity.

The commodity identifier may be, for example, a name, a type, a barcode or a two-dimensional code of the commodity.

The positioning unit 502 is configured to determine a current location of the user terminal based on the identifier of the user terminal.

For example, the positioning unit 502 may locate the user terminal based on the identifier of the user terminal by using a base station or GPS, to determine the current location of the user terminal.

The obtaining unit 503 is configured to obtain commodity information about the target commodity of stores within a preset range from a preset information database based on the current location obtained by the positioning unit 502 and the commodity identifier of the target commodity.

The commodity information may include the commodity identifier, an identifier of a general warehouse to which the commodity belongs, an identifier of a region warehouse to which the commodity belongs, an identifier of a store to which the commodity belongs, SKU information about the commodity in the general warehouse, SKU information about the commodity in the region warehouse, SKU information about the commodity in the store, and/or promotion information about the commodity in the store.

Besides the storage information, the SKU information may further include the number of original commodities, the number of the commodities which have been sold, and the number of the commodities which are remained.

The sending unit 504 is configured to return the commodity information about the target commodity of the stores within the preset range obtained by the obtaining unit 503, to the user terminal.

The preset range may he set according to requirement of practical application. For example, the preset range may be set to be 100 m, 500 m or 1000 m, or even may be set by using a journey such as a 5 minutes' walk, a 5 minutes' drive or a 10 minutes' drive.

The obtaining unit 503 may be configured to obtain stores having the commodity information about the target commodity from the preset information database based on the commodity identifier of the target commodity; select stores within the preset range centering on the current location from the stores having the commodity information about the target commodity; and obtain commodity information about the target commodity of the stores within the preset range.

The information database may be established by obtaining commodity information about various commodities in real time. As shown in FIG. 5b, the apparatus for processing the information about the commodity further includes an establishing unit 505.

The establishing unit 505 is configured to obtain commodity information about a specific commodity, such as one or more of: a commodity identifier of the specific commodity, an identifier of a general warehouse to which the commodity belongs, an identifier of a region warehouse to which the commodity belongs, an identifier of a store to which the commodity belongs, stock information about the commodity in the general warehouse, stock information about the commodity in the region warehouse, stock information about the commodity in the store, and promotion information about the commodity in the store. The establishing unit then establishes the information database based on the commodity information about the specific commodity.

For example, the establishing unit 505 may be configured to receive the commodity information about the specific commodity uploaded by various merchants via a standard data interface or an adapter.

The commodity information uploaded by the merchant may be uploaded actively by the merchant, or uploaded by the merchant according to a prompt by a system after automatic system detection. In addition, both the standard data interface and the adapter can be connected to ERP of the merchant, therefore there is no need to modify the existing ERP system.

In addition, after the information database is established based on the commodity information, the information database may be updated in real time. For example, the information database may be updated when the commodity information is changed or according to a preset period based on an increment synchronization strategy. As shown in FIG. 5b, the apparatus for processing the information about the commodity further includes an update unit 506.

The update unit 506 is configured to update the information database when the commodity information is changed or at a preset period according to a preset increment synchronization strategy.

The increment synchronization strategy may be set according to requirement of practical application. For example, a synchronization time or a synchronization mode may be set; for example, it may be set that the synchronization is performed in the unit of hour and the update is only for the changed data to reduce system load.

Optionally, in a case that the request for viewing the information about the target commodity further carries a scope for viewing the target commodity, the obtained commodity information is further screened according to the scope for viewing the target commodity after the request for viewing the information about the target commodity sent by the user terminal is received. That is, the apparatus for processing the information about the commodity further includes a screening unit 507.

The screening unit 507 is configured to screen the obtained commodity information about the target commodity of the nearby stores according to the scope for viewing the target commodity, to obtain screened commodity information.

For example, the screening unit 507 screens out commodity information meeting the scope (i.e., the scope for viewing the target commodity) from the obtained commodity information about the target commodity of the nearby stores according to a region for viewing by the user, a price range of the commodity, a type of the commodity and/or a color of the commodity.

In this case, the sending unit 504 may be configured to return the screened commodity information to the user terminal.

In an implementation, each of the above units may be implemented as an independent entity, or as one entity or several entities by means of combination. Specific implementation of each unit may refer to the method of the above embodiments, and the detail description is omitted herein.

The apparatus for processing the information about the commodity may be integrated into a device such as a server.

From the above, in the embodiment of the disclosure, the receiving unit 501 of the apparatus for processing the information about the commodity may receive the request for viewing the information about the target commodity sent by the user terminal; the positioning unit 502 locates the user terminal based on the terminal identifier carried in the request for viewing the information about the target commodity, to determine the current location of the user terminal; the obtaining unit 503 obtains the commodity information about the target commodity of stores within the preset range from the preset information database based on the current location and the commodity identifier of the target commodity; and then the sending unit 504 returns the commodity information to the user terminal. The commodity information includes: a commodity identifier, an identifier of a general warehouse to which the commodity belongs, an identifier of a region warehouse to which the commodity belongs, an identifier of a store to which the commodity belongs, SKU information about the commodity in the general warehouse, SKU information about the commodity in the region warehouse, SKU information about the commodity in the store, and/or promotion information about the commodity in the store. In the solution, the commodity information about the target commodity of the stores within the preset range can be provided to the user terminal based on the current location of the user terminal, therefore the user can obtain accurate commodity information fully and in a timely manner. In addition, in the solution, the commodity information not only includes online commodity, but also includes other offline information such as storage information and other information about the commodity of the various stores. That is, the online commodity information and the offline commodity information are synchronized. Therefore, accurate and full commodity information can be provided to the user, which is convenient to the user, improves the quality of user experience, and further improves transaction achievement.

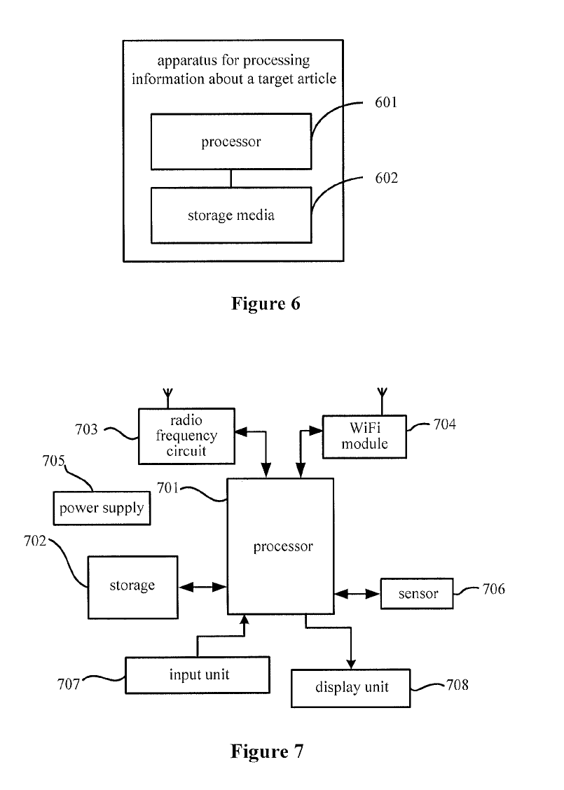

Another apparatus for processing information about a target article is provided according to an embodiment of the disclosure. FIG. 6 is a structure schematic diagram of the apparatus. The apparatus includes one or more processors 601 and a storage medium 602 having operation instructions stored thereon that, when executed by processor, cause the processor 601 to perform the following steps:

receiving a request for viewing information about a target article sent by a user terminal, where the request for viewing the information about the target article includes an identifier of the target article and a terminal identifier;

determining a current location of the user terminal based on the terminal identifier;

obtaining, based on the current location of the user terminal and the identifier of the target article, information about the target article located within a preset range centering on the current location of the user terminal, from a preset information database; and

returning the obtained information about the target article to the user terminal.

In an embodiment, in a case that the request for viewing the information about the target article further carries a standard for viewing the target article, the processor 601, when executing the operation instructions in the storage medium 602, further performs the following steps:

screening the obtained information about the target article located within the preset range centering on the current location of the user terminal based on the standard for viewing the target article, to obtain screened information about the target article; and

returning the screened information about the target article to the user terminal.

In an embodiment, the processor 601, when executing the operation instructions in the storage medium 602, further performs the following steps:

obtaining information about articles; and

establishing the information database based on the information about the articles.

In an embodiment, the processor 601, when executing the operation instructions in the storage medium 602, further performs the following steps:

updating the information database when the information about the articles is changed or at a preset period according to a preset increment synchronization strategy.

Correspondingly, a communication system is further provided according to an embodiment of the disclosure, which includes any apparatus for processing the information about the target article according to embodiments of the disclosure. An example is as follows.

An apparatus for processing information about a commodity may be configured to receive a request for viewing information about a target commodity, which includes a commodity identifier of the target commodity and a terminal identifier, sent by a user terminal; determine a current location of the user terminal based on the terminal identifier; obtain, based on the current location and the commodity identifier of the target commodity, commodity information about the target commodity of stores within a preset range, from a preset information database; and return, to the user terminal, the commodity information about the target commodity of the stores within the preset range.

The nearby stores refer to stores within a preset range centering on the current location. The preset range may be set according to requirement of practical application. For example, the preset range may be set to be 100 m, 500 m or 1000 m, or even may be set by using a journey such as a 5 minutes' walk, a 5 minutes' drive, or a 10 minutes' drive. The detailed description thereof is omitted.

The apparatus for processing the information about the commodity may be configured to obtain stores having the commodity information about the target commodity from the preset information database based on the commodity identifier of the target commodity; select stores within the preset range centering on the current location from the stores having the commodity information about the target commodity; and then obtain commodity information about the target commodity of the stores within the preset range.

The request for viewing the information about the target commodity further carries information such as a scope for viewing the target commodity, besides the commodity identifier of the target commodity and the terminal identifier. The commodity identifier may be, for example, a name, a type, a barcode or a two-dimensional code of the commodity. The scope for viewing the target commodity may be a region for viewing, a price range of the commodity, a type of the commodity, and/or a color of the commodity.

Optionally, in a case that the request for viewing the information about the target commodity further carries the scope for viewing the target commodity,

the apparatus for processing the information about the commodity may be further configured to screen the obtained commodity information about the target commodity of the nearby stores based on the scope for viewing the target commodity, to obtain screened commodity information; and then send the screened commodity information to the user terminal.

For example, the commodity information meeting the scope (i.e., the scope for viewing the target commodity) may be screened out from the obtained commodity information about the target commodity of stores within the preset range based on the region for viewing by the user, the price range of the commodity, the type of the commodity, and/or the color of the commodity. For convenience of description, the commodity information meeting the scope which is screened out is referred to as screened commodity information in embodiments of the disclosure.

The commodity information includes: a commodity identifier, an identifier of a general warehouse to which the commodity belongs, an identifier of a region warehouse to which the commodity belongs, an identifier of a store to which the commodity belongs, SUK information (short for stock information) about the commodity in the general warehouse, SKU information about the commodity in the region warehouse, SKU information about the commodity in the store, and/or promotion information about the commodity in the store.

Resides the storage information, the SKU information may further include the number of original commodities, the number of the commodities which have been sold, and the number of the commodities which are remained.

The information database may be established by obtaining commodity information about various commodities in real time.

The apparatus for processing the information about the commodity is further configured to obtain commodity information about a specific commodity, such as one or more of: a commodity identifier of the specific commodity, an identifier of a general warehouse to which the commodity belongs, an identifier of a region warehouse to which the commodity belongs, an identifier of a store to which the commodity belongs, stock information about the commodity in the general warehouse, stock information about the commodity in the region warehouse, stock information about the commodity in the store, and promotion information about the commodity in the store; and then establish an information database based on the commodity information about the specific commodity.

For example, the commodity information about the specified commodity uploaded by various merchants may be received via a standard data interface or an adapter.

The commodity information uploaded by the merchant may be uploaded actively by the merchant, or uploaded by the merchant according to a prompt by a system after automatic system detection. In addition, both the standard data interface and the adapter can be connected to ERP of the merchant, therefore there is no need to modify the existing ERP system.

In addition, after the information database is established based on the commodity information, the apparatus for processing the information about the commodity may further update the information database in real time. For example, the information database may be updated when the commodity information is changed or at a preset period according to a preset increment synchronization strategy.

The increment synchronization strategy may be set according to requirement of practical application. For example, a synchronization time or a synchronization mode may be set; for example, it may be set that the synchronization is performed in the unit of hour and the update is only for the changed data to reduce system load.

The apparatus for processing the information about the commodity may be integrated into a device such as a server. The implementation of the apparatus for processing the information about the commodity may refer to the above embodiments, which is not described herein.

In addition, the communication system may further include other devices such as a user terminal and an EPR system of the merchant.

The user terminal is configured to send a request for viewing the information about the target commodity to the apparatus for processing the information about the commodity (for example, a server), and receive the information about the commodity returned by the apparatus for processing the information about the commodity (for example, a server).

The EAR system of the merchant is configured to send the information about the commodity to the apparatus for processing the information about the commodity (for example, a server).

The implementation of each of the above devices may refer to the above embodiments, which is not described herein.

From the above, in the embodiment of the disclosure, the apparatus for processing the information about the commodity of the communication system receives the request for viewing the information about the target commodity sent by the user terminal; locates the user terminal based on the terminal identifier carried in the request for viewing the information about the target commodity to determine the current location of the user terminal; obtains the commodity information about the target commodity of stores within a preset range from the preset information database based on the current location and the commodity identifier of the target commodity; and returns the commodity information about the target commodity of the stores within the preset range to the user terminal. In the solution, the commodity information about the target commodity of the stores within the preset range can be provided to the user terminal based on the current location of the user terminal, therefore the user can obtain accurate information about the commodity fully and in a timely manner, which is convenient to the user, improves the quality of user experience, and further improves transaction achievement.

In addition, a server is provided according to an embodiment of the disclosure, into which the apparatus for processing the information about the target article according to the embodiment of the disclosure can be integrated. FIG. 7 illustrates a structure schematic diagram of the server involved in the embodiment of the disclosure.

The server may include one or more processors 701 as processing cores, one or more storages 702 of a computer readable storage medium, a radio frequency (RF) circuit 703, a wireless communication module 704 such as a blue tooth module and/or a wireless fidelity (WiFi) module (a WIFI module 704 is taken as an example in FIG. 7), a power supply 705, a sensor 706, an input unit 707 and a display unit 708. It should be understood by those skilled in the art that the server is not limited by the structure of the server shown in FIG. 7, and the server may include more or less components than those shown in FIG. 7, or some components may be combined, or the components may be differently arranged.

The processor 701 is a control center of the server, is connected to various parts of the whole server via various interfaces and various circuits, and performs various functions of the server and processes data by running or executing software programs and/or software modules stored in the storage 702 and invoking data stored in the storage 702, to monitor the server as a whole. Optionally, the processor 701 may include one or more processing cores. Preferably, the processor 701 may integrate an application processor and a modem processor. The application processor mainly processes an operating system, a user interface and an application program. The modem processor mainly processes wireless communication. It may be understood that the above modern processor may be not integrated into the processor 701.

The storage 702 may be configured to store software programs and software modules. The processor 701 performs various function applications and processes data by running the software programs and the software modules stored in the storage 702. The storage 702 may mainly include a program storage area and a data storage area. The program storage area may store an operating system, at least one application program required by a function (for example, an audio playback function, image display function). The data storage area may store data built during the usage of the server. In addition, the storage 702 may include a high speed random access memory and may further include a non-transitory storage, for example, at least one disk storage, flash memory device or other transitory solid-state memory. Accordingly, the storage 702 may further include a memory controller to provide an access for the processor 701 to the storage 702.

The RF circuit 703 may be configured to receive and send a signal in a process of sending and receiving a message. Specifically, the RF circuit delivers the downlink information received from a base station to the one or more processor 701 for processing, and transmits related uplink data to the base station. Generally, the RF circuit 703 includes but not limited to an antenna, at least one amplifier, a tuner, one or more oscillators, a subscriber identity module (SIM) card, a transceiver, a coupler, a low noise amplifier (LNA), a diplexer and so on. In addition, the RF circuit 703 may also communicate with other devices and network via wireless communication. The wireless communication may use any communication standard or protocol, including but not limited to global system of mobile communication (GSM), general packet radio service (GPRS), code division multiple access (CDMA), wideband code division multiple access (WCDMA), long term evolution (LTE), e-mail, short messaging service (SMS) and so on.

WiFi belongs to a short-range wireless transmission technique. The server receives and sends E-mail and accesses to a streaming media via the WiFi module 704, which may provide wireless broadband Internet access. Although the WiFi module 704 is shown in FIG. 7, it can be understood that the WiFi module 704 is not necessary for constituting a server and may be not presented as needed within the scope of the essence of the disclosure.

The server may further include the power supply 705 (such as a battery) to power various components. Preferably, the power supply may be logically connected with the processor 701 via a power management system, so that management of functions such as charging, discharging and power consumption can be realized with the power supply management system. The power supply 705 may further include one or more direct current or alternating current power supplies, a rechargeable system, a power fault detection circuit, a power adapter or inverter, a power status indicator, and so on.

The server may further include at least one sensor 706, such as an optical sensor, a motion sensor, and other sensors. The server may be further equipped with other sensors such as a gyroscope, a barometer, a hygrometer, a thermometer, an infrared sensor, which are not described herein.

The server may further includes the input unit 707. The input unit 707 may be configured to receive input number information or character information, and to generate a signal input of a keyboard, a mouse, a joystick, an optical signal or a trackball, which is related to a user setting and a function control. Specifically, in a specific embodiment, the input unit 707 may include a touch sensitive surface and other input devices. The touch sensitive surface is also known as a touch screen or a touch panel, which may be used to collect a touch operation by a user on or near the touch sensitive surface (such as an operation on or near the touch sensitive surface by a user with any suitable object or accessory such as a finger, a touch pen), and drive corresponding connection devices according to a pre-set procedure. Optionally, the touch sensitive surface may include two parts, i.e., a touch detection apparatus and a touch controller. The touch detection apparatus detects touch orientation of a user and a signal generated by the touch operation, and transmits the signal to the touch controller. The touch controller receives touch information from the touch detection apparatus, converts the touch information into touch coordinates and transmits the touch coordinates to the processor 701. The touch controller can further receive and execute a command sent from the processor 701. The touch sensitive surface may be of multiple types such as a resistive touch, a capacitive touch, an infrared touch and a surface acoustic wave touch. In addition to the touch sensitive surface, the input unit 707 may also include other input devices. Specifically, the other input devices may include, but not limited to one or more of a physical keyboard, a function key (such as a volume control button, a switch button), a track ball, a mouse and a joystick.

The server may further include the display unit 708. The display unit 708 may be configured to display information input by a user or information provided to the user and various graphical user interfaces of the server. The graphical user interfaces may be formed of a graphic, a text, an icon, a video, and any combination thereof. The display unit 708 may include a display panel. Optionally, the display panel may be formed in a form of a liquid crystal display (LCD), or an organic light-emitting diode (OLED). In addition, the display panel may be covered by a touch sensitive surface. When a touch operation on or near the touch sensitive surface is detected by the touch sensitive surface, the touch sensitive surface transmits the touch operation to the processor 701 to determine the type of the touch event. The processor 701 then provides a corresponding visual output on the display panel based on the type of the touch event. Although the touch sensitive surface and the display panel implement the input and output functions as two separate components in FIG. 7, the touch sensitive surface and the display panel may be integrated together to implement the input and output function3 in some embodiments.

Although not shown, the server may further include a camera, a Bluetooth module, etc, which are not described herein. Specifically in the embodiment, the processor 701 in the server may load one or more executable files corresponding to a progress of an application program into the storage 702 according to following instruction, and executes the application program stored in the storage 702 to implement various functions as follows:

receiving a request for viewing information about a target article sent by a user terminal, where the request for viewing the information about the target article includes an identifier of the target article and a terminal identifier; determining a current location of the user terminal based on the terminal identifier; obtaining, based on the current location of the user terminal and the identifier of the target article, information about the target article located within a preset range centering on the current location of the user terminal, from a preset information database; and returning the obtained information about the target article to the user terminal.

In a case that the target article is a commodity that can be sold online and offline, the processor 701 executes the application program stored in the storage 702 to implement the following functions:

receiving a request for viewing information about the target commodity sent by a user terminal, where the request carries a commodity identifier of the target commodity and a terminal identifier; determining a current location of the user terminal based on the terminal identifier; obtaining, based on the current location and the commodity identifier of the target commodity, commodity information about the target commodity of stores within a preset range, from a preset information database; and returning the obtained commodity information about the target commodity of the stores within the preset range to the user terminal.

The preset range may be set according to requirement of practical application. For example, the preset range may be set to be 100 m, 500 m, or 1000 m, or even may be set by using a journey such as a 5 minutes' walk, a 5 minutes' drive, and a 10 minutes' drive, which is not described herein.

The processor may further obtain stores having the commodity information about the target commodity from the preset information database based on the commodity identifier of the target commodity; select stores within the preset range centering on the current location from the stores having the commodity information about the target commodity; and obtain commodity information about the target commodity of the stores within the preset range.

The request for viewing the information about the target commodity may further include information such as a scope for viewing the target commodity, besides the commodity identifier of the target commodity and the terminal identifier. The commodity identifier may be, for example, a name, a type, a barcode or a two-dimensional code of the commodity. The scope for viewing the target commodity may be a region for viewing, a price range of the commodity, a type of the commodity, and/or a color of the commodity, etc.

Optionally, in a case that the request for viewing the information about the target commodity further carries a scope for viewing the target commodity, the obtained commodity information about the target commodity of the nearby stores is further screened based on the scope for viewing the target commodity, to obtain screened commodity information, after receiving the request for viewing the information about the target commodity sent by the user terminal; and the screened commodity information is sent to the user terminal.

For example, commodity information meeting the scope (i.e., the scope for viewing the target commodity) may be screened out from the obtained commodity information about the target commodity of the nearby stores, based on a region for viewing by the user, a price range of the commodity, a type of the commodity and/or a color of the commodity, to obtain screened commodity information.

The information database may be established by obtaining commodity information about a specific commodity in real time, that is, the processor may further perform the following operations:

obtaining commodity information about a specific commodity; and establishing the information database based on the commodity information about the specific commodity.

For example, the commodity information about the specified commodity uploaded by various merchants may be received via a standard data interface or an adapter.

The commodity information uploaded by the merchant may be uploaded actively by the merchant, or uploaded by the merchant according to a prompt by a system after automatic system detection. In addition, both the standard data interface and the adapter can be connected to ERP of the merchant, therefore there is no need to modify the existing ERP system.

The commodity information includes a commodity identifier, an identifier of a general warehouse to which the commodity belongs, an identifier of a region warehouse to which the commodity belongs, an identifier of a store to which the commodity belongs, SKU information (short for stock information) about the commodity in the general warehouse, SKU information about the commodity in the region warehouse, SKU information about the commodity in the store, and/or promotion information about the commodity in the store.

Besides the storage information, the SKU information may further include the number of original commodities, the number of the commodities which has been sold, and the number of the commodities which are remained.

In addition, after the information database is established based on the commodity information, the information database may be updated in real time. For example, the information database may be updated when the commodity information is changed or at a preset period according to a preset increment synchronization strategy.

The increment synchronization strategy may be set according to requirement of practical application. For example, a synchronization time or a synchronization mode may be set; for example, it may be set that the synchronization is performed in the unit of hour and the update is only for the changed data to reduce system load.

The implementations of the above various operations may refer to the above embodiments, which are not described herein.

From the above, in the embodiment of the disclosure, the server receives the request for viewing the information about the target commodity sent by the user terminal; locates the user terminal based on the terminal identifier carried in the request for viewing the information about the target commodity, to determine the current location of the user terminal; obtains commodity information about the target commodity of stores within a preset range from the preset information database based on the current location and the commodity identifier of the target commodity; and returns the commodity information about the target commodity of the stores within the preset range to the user terminal. In the solution, the commodity information about the target commodity of the stores within the preset range can be provided to the user terminal based on the current location of the user terminal, therefore the user can obtain accurate information about the commodity fully and in a timely manner, which is convenient to the user, improves the quality of user experience, and further improves transaction achievement.

It is understood by a person of skills in the art that all or some of steps in the various methods of the above embodiments may be achieved by instructing related hardware via a program. The program may be stored in a computer readable storage media. The storage media may include a read only memory (ROM), a random access memory (RAM), a magnetic disk or an optical disc.

A method, an apparatus and a system for processing information about a target article provided according to embodiments of the disclosure are described in detail. The principle and implementations of the invention are illustrated by applying specific examples in the disclosure. The foregoing embodiments are only used to facilitate an understanding of methods and core idea of the invention; meantime, specific implementations and application scope may he changed by those skilled in the art based on the core idea of the invention. In view of the foregoing, the contents of the specification should not be constructed as limiting the invention.

1. A method for processing information about a target article, comprising:
receiving a request for viewing the information about the target article sent by a user terminal, wherein the request for viewing the information about the target article comprises an identifier of the target article and a terminal identifier;
determining a current location of the user terminal based on the terminal identifier;
obtaining, based on the current location of the user terminal and the identifier of the target article, the information about the target article located within a preset range centering on the current location of the user terminal, from a preset information database; and
returning the obtained information about the target article to the user terminal.

2. The method according to claim 1, wherein the request for viewing the information about the target article further carries a standard for viewing the target article, and after obtaining, based on the current location and the identifier of the target article, the information about the target article located within the preset range centering on the current location of the user terminal, from the preset information database, the method further comprises:
screening, based on the standard for viewing the target article, the obtained information about the target article located within the preset range centering on the current location of the user terminal, to obtain screened information about the target article.

3. The method according to claim 2, wherein returning the obtained information about the target article to the user terminal comprises:
returning the screened information about the target article to the user terminal.

4. The method according to claim 1, wherein before receiving the request for viewing the information about the target article sent by the user terminal, the method further comprises:
obtaining information about the target article; and
establishing the preset information database based on the information about the target article.

5. The method according to claim 4, wherein after establishing the preset information database based on the information about the article, the method further comprises:
updating the preset information database when the information about the target article is changed or at a preset period according to a preset increment synchronization strategy.

6. The method according to claim 4, wherein obtaining the information about the target article comprises:
receiving the information about the target article via a standard data interface or an adapter.

7. An apparatus for processing information about a target article, comprising one or more processors and a non-transitory storage medium having operation instructions stored thereon, that when executed by the processor, cause the processor to perform the steps of:
receiving a request for viewing information about the target article sent by a user terminal, wherein the request for viewing the information about the target article comprises an identifier of the target article and a terminal identifier;
determining a current location of the user terminal based on the terminal identifier;
obtaining, based on the current location and the identifier of the target article, the information about the target article located within a preset range centering on the current location of the user terminal, from a preset information database; and
returning the obtained information about the target article to the user terminal.

8. The apparatus according to claim 7, wherein the request for viewing the information about the target article further carries a standard for viewing the target article, and the processor further performs the steps of:
screening, based on the standard for viewing the target article, the obtained information about the target article located within the preset range centering on the current location of the user terminal, to obtain screened information about the target article.

9. The apparatus according to claim 8, wherein the processor further performs the steps of:
returning the screened information about the target article to the user terminal.

10. The apparatus according to claim 7, wherein the processor further performs the steps of:
obtaining information about an article; and
establishing the preset information database based on the information about the article.

11. The apparatus according to claim 10, wherein the processor further performs the steps of:
updating the preset information database when the information about the article is changed or at a preset period according to a preset increment synchronization strategy.

12. A non-transient computer-readable storage medium storing, operation instructions, that when executed by a processor, cause the processor to perform the steps of:
receiving a request for viewing information about a target article sent by a user terminal, wherein the request for viewing the information about the target article comprises an identifier of the target article and a terminal identifier;
determining a current location of the user terminal based on the terminal identifier;
obtaining, based on the current location of the user terminal and the identifier of the target article, the information about the target article located within a preset range centering on the current location of the user terminal, from a preset information database; and
returning the obtained information about the target article to the user terminal.

13. The non-transient computer-readable storage medium according to claim 12, wherein the request for viewing the information about the target article further carries a standard for viewing the target article, and after obtaining, based on the current location and the identifier of the target article, the information about the target article located within the preset range centering on the current location of the user terminal, from the preset information database, the processor performs the step of:
screening, based on the standard for viewing the target article, the obtained information about the target article located within the preset range centering on the current location of the user terminal, to obtain screened information about the target article.

14. The non-transient computer-readable storage medium according to claim 12, wherein returning the obtained information about the target article to the user terminal comprises the step of:
returning the screened information about the target article to the user terminal.

15. The non-transient computer-readable storage medium according to claim 12, wherein before receiving the request for viewing the information about the target article sent by the user terminal, the processor performs the steps of:
obtaining information about the target article; and
establishing the preset information database based on the information about the target article.

16. The non-transient computer-readable storage medium according to claim 15, wherein after establishing the preset information database based on the information about the target article, the processor performs the step of:
updating the preset information database when the information about the target article is changed or at a preset period according to a preset increment synchronization strategy.

17. The non-transient computer-readable medium according to claim 15, wherein obtaining the information about the target article comprises:
receiving the information about the target article via a standard data interface or an adapter.
